(19) United States
(12) Patent Application Publication
(10) Pub. No.: US 2022/0129340 A1
(43) Pub. Date: Apr. 28, 2022

(54) INFORMATION PROCESSING DEVICE AND INFORMATION PROCESSING METHOD

(71) Applicant: Nippon Telegraph and Telephone Corporation, Tokyo (JP)

(72) Inventors: Noriyuki SATO, Tokyo (JP); Takuo KANAMITSU, Tokyo (JP)

(21) Appl. No.: 17/427,717

(22) PCT Filed: Jan. 27, 2020
(86) PCT No.: PCT/JP2020/002678

§ 371 Date: Aug. 2, 2021

(30) Foreign Application Priority Data
Feb. 6, 2019 (JP) 2019-019340

(51) Int. Cl. G06F 11/07; G06F 17/16

(52) U.S. Cl. CPC G06F 11/0754; G06F 17/16

(57) ABSTRACT

Even when a processing unit that processes a plurality of pieces of information has a failure, significant information is prevented from being output erroneously. An information processing device 100 including a processing unit 1 that processes a plurality of pieces of information includes: an addition unit 2A that adds eigenvalues for input memories 20000 to 21023 to values of a plurality of pieces of information 40000 to 41023; a subtraction unit 2B that subtracts the eigenvalues from the plurality of pieces of added information 70000 to 71023 having no overlapping of the values, processed by the processing unit 1; output memories 30000 to 31023 that store the plurality of pieces of processed information 50000 to 51023; and a determination unit 3 that determines whether the value of each of the pieces of processed information 50000 to 51023 is within a predetermined range and outputs the processed information as invalid information when the value is outside the range.

### TECHNICAL FIELD

The present invention relates to an information processing device and an information processing method.

### BACKGROUND ART

A conventional information processing device including one processing unit, in which a plurality of pieces of information is processed by the processing unit is known. Such an information processing device includes a plurality of input memories and a plurality of output memories in order to process a plurality of pieces of information. For example, when an information processing device processes 1024ch pieces of information (“ch” is an abbreviation of channel), the information processing device includes 1024ch pieces of input memories and 1024ch pieces of output memories.

When a processing unit is normal, the processing unit reads Nch-th information (N=0, 1, . . . , 1022, 1023) from an Nch-th input memory, processes the Nch-th information, and writes the processed information to an Nch-th output memory. However, when the processing unit has a failure, the processing unit may read Nch-th information from an Nch-th input memory, process the Nch-th information, and erroneously write the processed information to an Mch-th output memory (M =0, 1, . . . , 1022, 1023 and M≠N). As a result, Mch-th information different from the original one is output to a receiver who should receive the Nch-th information.

However, conventionally, even if the processing unit has a failure, there has been no means for detecting the failure in a short time. Therefore, there is a problem that it is difficult to prevent significant information processed for the output memory of a target channel from being output erroneously. Particularly, digital signal processing by DSP (Digital Signal Processor) (see NPL 1) as a processing unit must be completed within a predetermined time (latency) and the processing speed tends to be prioritized. Therefore, conventionally, correcting processing errors such as channel replacement has been neglected.

### CITATION LIST

### Non Patent Literature

[NPL 1] “Digital Signal Processor”, [online], [Retrieved on Jan. 7, 2019], Internet <URL: https://ja.wikipedia.org/wiki/

[symbol]

### SUMMARY OF THE INVENTION

### Technical Problem

With the foregoing in view, an object of the present invention is to prevent significant information from being output erroneously even when a processing unit that processes a plurality of pieces of information has a failure.

### Means for Solving the Problem

In order to solve the above-described problems, the invention described in Claim 1 is an information processing device including a processing unit that processes a plurality of pieces of information, including: input memories That store respective pieces of the plurality of pieces of information; an addition unit that adds eigenvalues for the respective input memories to values of the plurality of pieces of information and generates a plurality of pieces of added information so that there is no overlap of the values between the plurality of pieces of added information; a subtraction unit that subtracts the eigenvalues of the respective input memories from the respective pieces of the plurality of pieces of added information processed by the processing unit and generates a plurality of pieces of processed information; output memories that store respective pieces of the plurality of pieces of processed information; and a determination unit that determines whether a value of the processed information stored in each of the output memories is within a predetermined range and outputs the processed information as invalid information when the value is outside the predetermined range.

The invention described in Claim 3 is an information processing method in an information processing device including a processing unit that processes a plurality of pieces of information, the information processing device executing: storing respective pieces of the plurality of pieces of information in input memories; adding eigenvalues for the respective input memories to values of the plurality of pieces of information and generating a plurality of pieces of added information so that there is no overlap of the values between the plurality of pieces of added information; subtracting the eigenvalues of the respective input memories from the respective pieces of the plurality of pieces of added information processed by the processing unit and generating a plurality of pieces of processed information; storing respective pieces of the plurality of pieces of processed information in output memories; and determining whether a value of the processed information stored in each of the output memories is within a predetermined range and outputting the processed information as invalid information when the value is outside the predetermined range.

According to the inventions described in claims 1 and 3, even when a processing unit that processes a plurality of pieces of information has a failure, it is possible to output only significant information.

Therefore, even when a processing unit that processes a plurality of pieces of information has a failure, it is possible to prevent significant information from being output erroneously.

The invention described in Claim 2 is the information processing device described in Claim 1 in which the eigenvalue is set on the basis of a channel number of the input memory and a range of values that the plurality of pieces of information can take.

The invention described in Claim 4 is the information processing method described in Claim 3 in which the eigenvalue is set on the basis of a channel number of the input memory and a range of values that the plurality of pieces of information can take.

According to the inventions described in claims 2 and 4, it is possible to provide a simple means based on a channel number of an input memory as means for setting an eigenvalue.

### Effects of the Invention

According to the present invention, even when a processing unit that processes a plurality of pieces of information has a failure, it is possible to prevent significant information from being output erroneously.

### BRIEF DESCRIPTION OF DRAWINGS

FIG. 1 is as example of a functional configuration diagram of an information processing device according to the present embodiment and is an explanatory diagram when a processing unit is normal.

FIG. 2 is an explanatory diagram when the processing unit is normal.

FIG. 3 is an example of a function configuration diagram of the information processing device according to the present embodiment and is an explanatory diagram when the processing unit has a failure.

FIG. 4 is an explanatory diagram when a processing unit has a failure.

FIG. 5 is a flowchart illustrating processing of the information processing device according to the present embodiment.

### DESCRIPTION OF EMBODIMENTS

Hereinafter, a mode (an embodiment) for carrying out of the present invention will be described with reference to the drawings.

[Configuration]

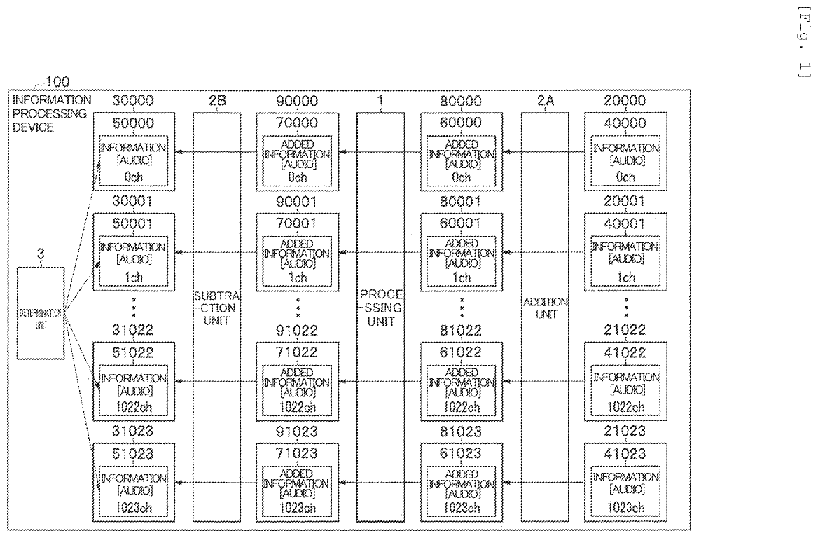

As illustrated in FIG. 1, an information processing device 100 of the present embodiment includes a processing unit 1, input memories 20000 to 21023, output memories 30000 to 31023, temporary input memories 80000 to 81023, temporary output memories 90000 to 91023, an addition unit 2A, a subtraction unit 2B, and a determination unit 3. In the present embodiment, it is assumed that the information processing device 100 processes 1024ch pieces of information.

The processing unit 1 processes a plurality of pieces of information. In the present embodiment, it is assumed that the information processing device 100 includes one processing unit 1. However, the present invention can be applied to cases where the information processing device 100 includes a plurality of processing units 1. The processing unit 1 may be a microcomputer or a DSP, for example, but there is no limitation thereto. Moreover, the processing of the processing unit 1 may be echo cancellation, codec conversion, and bandwidth compression, for example, but there is no limitation thereto.

The input memories 20000 to 21023 store 1024ch pieces of information 40000 to 41023 to be input to the information processing device 100, respectively. The pieces of information 40000 to 41023 are pieces of information before being processed by the processing unit 1. The pieces of information 40000 to 41023 may be audio, for example, but there is no limitation thereto. Moreover, the pieces of information 40000 to 41023 may be information (14-bit information) that takes any one of the values of 0 to 16,383, for example, but there is no limitation thereto.

The addition unit 2A adds eigenvalues unique to respective channels to the respective values of the 1024ch pieces of information 40000 to 41023 stored in the input memories 20000 to 21023, respectively, Moreover, the addition unit 2A generates respective pieces of information 40000 to 41023 to which the eigenvalues for respective channels are added as pieces of added information 60000 to 61023 and writes the same to the temporary input memories 80000 to 81023, respectively. The values of the pieces of added information 60000 to 61023 are “(values of pieces of information 40000 to 41023)+(eigenvalues of respective channels)”.

The eigenvalue of each channel can be set as (channel number)×16,384, for example. According to this setting, an eigenvalue is information of 24 bits (24=10+14), and each of the values of the pieces of added information 60000 to 61023 does not overlap with the values of the other pieces of added information 60000 to 61023. In other words, the eigenvalue may be set on the basis of the channel numbers of the input memories 20000 to 21023 and a range (0 to 16,383) of values that the plurality of pieces of information 40000 to 41023 can take. The relationship between the channel number and the eigenvalue may be set arbitrarily as long as overlapping of the values of the pieces of added information 60000 to 61023 can be avoided.

The temporary input memories 80000 to 81023 store the pieces of added information 60000 to 61023, respectively. The pieces of added information 60000 to 61023 are pieces of added information before being processed by the processing unit 1.

The temporary output memories 90000 to 91023 store pieces of added information 70000 to 71023, respectively. The pieces of added information 70000 to 71023 are pieces of added information processed by the processing unit 1.

When the processing unit 1 is normal, the processing unit 1 reads Nch-th added information (N=0, 1, . . . , 1022, 1023) from an Nch-th temporary input memory, processes the Nch-th added information, and writes the processed added information to an Nch-th temporary output memory.

The subtraction unit 2B subtracts eigenvalues unique to respective channels added to the respective values of 1024ch pieces of added information 70000 to 71023 stored in the temporary output memories 90000 to 91023 from the values of pieces of added information 70000 to 71023, respectively. Moreover, the subtraction unit 2B generates respective pieces of added information 70000 to 71023 from which eigenvalues of respective channels (eigenvalues that take the same values as the added eigenvalues) are subtracted as pieces of information 50000 to 51023 and writes the same to the output memories 30000 to 31023, respectively. The values of the pieces of processed information 50000 to 51023 are “(values of pieces of information 40000 to 41023)+(eigenvalues of respective channels)−(eigenvalues of respective channels)”.

The output memories 30000 to 31023 store 1024ch pieces of information 50000 to 51023 output to a receiver (not illustrated) from the information processing device 100, respectively. The pieces of information 50000 to 51023 are pieces of processed information (information to which eigenvalues of respective channels are not added) processed by the processing unit 1. The pieces of information 50000 to 51023 may be audio, for example, but there is no limitation thereto.

When reading Nch-th added information from an Nch-th temporary input memory, the processing unit 1 also reads an Nch-th eigenvalue (an eigenvalue corresponding to the Nch-th input memory and the Nch-th temporary input memory) which is added to the Nch-th added information. When processing the Nch-th added information, the processing unit 1 retains the Nch-th eigenvalue which is added to the value of the Nch-th added information without changing the same. The processing unit 1 writes the processed Nch-th added information to the Nch-th temporary output memory. The subtraction unit 2B subtracts the Nch-th eigenvalue from the processed Nch-th added information stored in the Nch-th temporary output memory and writes the processed Nch-th information to the Nch-th output memory. The output memories 30000 to 31023 have areas for storing the pieces of processed information 50000 to 51023, respectively, and store the pieces of information 50000 to 51023, respectively.

The determination unit 3 determines whether the values of the pieces of information 50000 to 51023 stored in the output memories 30000 to 31023, respectively, are values within a predetermined range. The predetermined range may be the range of values from 0 to 16,383 that the pieces of information 40000 to 41023 can take, but there is no limitation thereto. When the value of the information stored in the Nch-th output memory is a value out of the predetermined range, the determination unit 3 determines that the processing unit 1 has a failure and outputs the information stored in the Nch-th output memory as invalid information. Therefore, the determination unit 3 can prevent significant information processed for the target Nch-th output memory from being output erroneously.

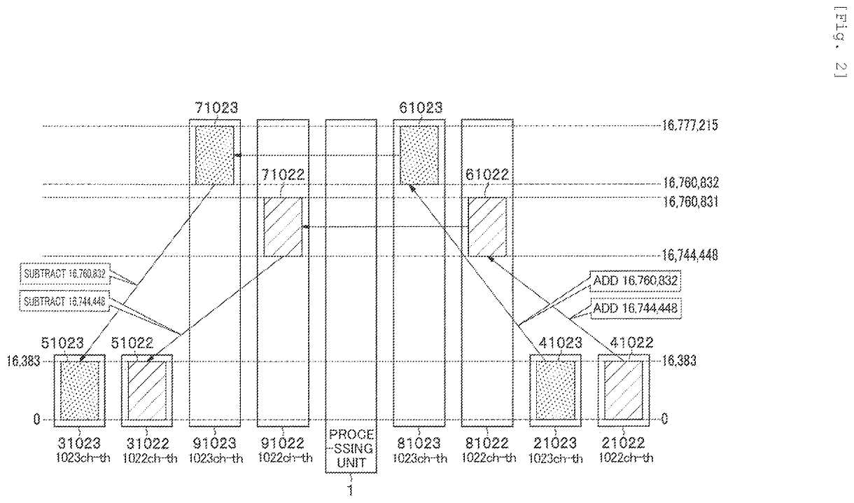

An operation example for the 1022ch-th information 41022 stored in the 1022ch-th input memory 21022 and the 1023ch-th information 41023 stored in the 1023ch-th input memory 21023 illustrated in FIG. 1 will be described. In description, FIGS. 2 to 4 are also referenced appropriately.

As illustrated in FIG. 2, when the processing unit 1 is normal, first, the addition unit 2A reads the 1022ch-th information 41022 from the 1022ch-th input memory 21022 and adds a 1022ch-th eigenvalue 16,744,448 (=1022×16,384) to the value (any one of 0 to 16,383) of the 1022ch-th information 41022. The value of the 1022ch-th added information 61022 is any one of 16,744,448 to 16,760,831 (=16,744,448+16,383). The 1022ch-th added information 61022 is stored in the temporary input memory 81022. The processing unit 1 reads the 1022ch-th added information 61022 from the temporary input memory 81022 and processes the same. In this processing, the 1022ch-th eigenvalue 16,744,448 is retained. After the information is processed, the processing unit 1 writes the 1022ch-th processed added information 71022 to the 1022ch-th temporary output memory 91022. The subtraction unit 2B reads the 1022ch-th processed added information 71022 from the 1022ch-th temporary output memory 91022 and subtracts the 1022ch-th eigenvalue 16,744,448 (=1022×16,384) from the value (any one of 16,744,448 to 16, 760, 831) of the 1022ch-th processed added information 71022. The value of the 1022ch-th processed information 51022 is any one of 0 to 16,383. The 1022ch-th processed information 51022 is stored in the 1022ch-th output memory 31022. The determination unit 3 reads the 1022ch-th processed information 51022 from the 1022ch-th output memory 31022 and determines whether the value of the 1022ch-th processed information 51022 is a value within a predetermined range (0 to 16,383). In this case, since the value is within the predetermined range, it is determined that the processing unit 1 is normal. Moreover, the determination unit 3 outputs the 1022ch-th processed information 51022 as significant information processed for the target 1022ch-th output memory 31022.

Similarly, as illustrated in FIG. 2, first, the addition unit 2A reads the 1023ch-th information 41023 from the 1023ch-th input memory 21023 and adds a 1023ch-th eigenvalue 16,760,832 (=1023×16,384) to the value (any one of 0 to 16,383) of the 1023ch-th information 41023. The value of the 1023ch-th added information 61023 is any one of 16,760,832 to 16,777,215 (=16,760,832+16,383). The 1023ch-th added information 61023 is stored in the temporary input memory 81023. The processing unit 1 reads the 1023ch-th added information 61023 from the temporary input memory 81023 and processes the same. In this processing, the 1023ch-th eigenvalue 16,760,832 is retained. After processing the information, the processing unit 1 writes the 1023ch-th processed added information 71023 to the 1023ch-th temporary output memory 91023. The subtraction unit 2B reads the 1023ch-th processed added information 71023 from the 1023ch-th temporary output memory 91023 and subtracts the 1023ch-th eigenvalue 16,760,832 (=1023×16,384) from the value (any one of 16,760,832 to 16,777,215) of the 1023ch-th processed added information 71023. The value of the 1023ch-th processed information 51023 is any one of 0 to 16,383. The 1023ch-th processed information 51023 is stored in the 1023ch-th output memory 31023. The determination unit 3 reads the 1023ch-th processed information 51023 from the 1023ch-th output memory 31023 and determines whether the value of the 1023ch-th processed information 51023 is a value within the predetermined value (0 to 16,383). In this case, since the value is within the predetermined range, it is determined that the processing unit 1 is normal. Moreover, the determination unit 3 outputs the 1023ch-th processed information 51023 as significant information processed for the target 1023ch-th output memory 31023.

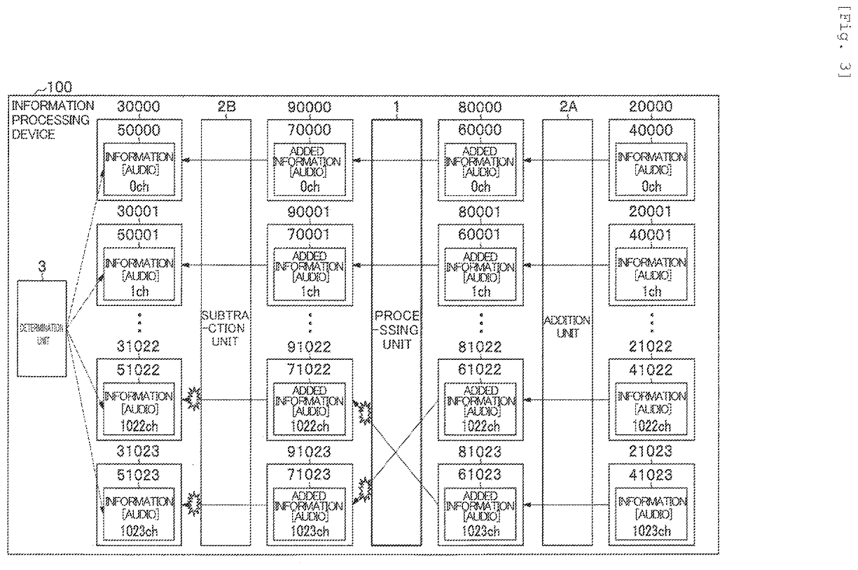

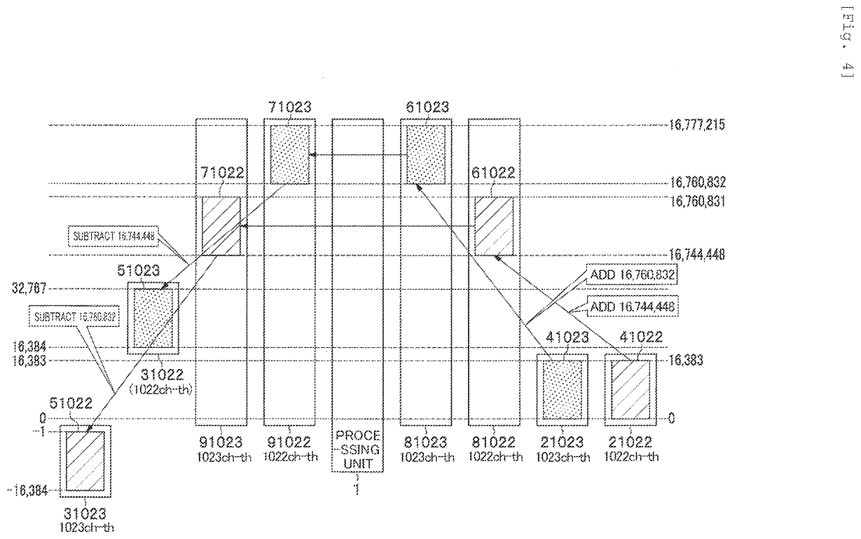

When the processing unit 1 has a failure, as illustrated in FIG. 3, it is assumed that, after the 1023ch-th added information 61023 stored in the 1023ch-th temporary input memory 81023 is processed, the 1023ch-th processed added information 71023 is stored in the 1022ch-th temporary output memory 91022. In this processing, the 1023ch-th eigenvalue 16,760,832 (=1023×16,384) is retained. Therefore, as illustrated in FIG. 4, the value of the 1023ch-th processed added information 71023 stored in the 1022ch-th temporary output memory 91022 is the same as the value (any one of 16,760,832 to 16,777,215) of the 1023ch-th added information 61023 stored in the 1023ch-th temporary input memory 81023. The subtraction unit 2B reads the 1023ch-th processed added information 71023 from the 1022ch-th temporary output memory 91022 and subtracts the 1022ch-th eigenvalue 16,744,448 (=1022×16,384) (an eigenvalue corresponding to the 1022ch-th input memory 21022 and the 1022ch-th temporary input memory 81022) from the value (any one of 16,760,832 to 16,777,215) of the 1023ch-th processed added information 71023. The value of the 1023ch-th processed information 51023 is any one of 16,384 to 32,767 (=16,384+16,383). The 1023ch-th processed information 51023 is stored in the 1022ch-th output memory 31022. The determination unit 3 reads the 1023ch-th processed information 51023 from the 1022ch-th output memory 31022 and determines whether the value of the 1023ch-th processed information 51023 is a value within the predetermined range (0 to 16,383). In this case, since the value is outside the predetermined range, it is determined that the processing unit 1 has a failure. Moreover, the determination unit 3 outputs the 1023ch-th processed information 51023 as invalid information that is outside the range of values of information to be processed by the processing unit 1.

Similarly, as illustrated in FIG. 3, it is assumed that, after the 1022ch-th added information 61022 stored in the 1022ch-th temporary input memory 81022 is processed, the 1022ch-th processed added information 71022 is stored in the 1023ch-th temporary output memory 91023. In this processing, the 1022ch-th eigenvalue 16,744,448 (=1022×16,384) is retained. Therefore, as illustrated in FIG. 4, the value of the 1022ch-th processed added information 71022 stored in the 1023ch-th temporary output memory 91023 is the same as the value (any one of 16,744,448 to 16,760,831) of the 1022ch-th added information 61022 stored in the 1022ch-th temporary input memory 81022. The subtraction unit 2B reads the 1022ch-th processed added information 71022 from the 1023ch-th temporary output memory 91023 and subtracts the 1023ch-th eigenvalue 16,760,832 (=1023×16,384) (an eigenvalue corresponding to the 1023ch-th input memory 21023 and the 1023ch-th temporary input memory 81023) from the value (any one of 16,744,448 to 16,760,831) of the 1022ch-th processed added information 71022. The value of the 1022ch-th processed information 51022 is any one of −16,384 (=0-16,384) to −1 (=16,383-16,384). The 1022ch-th processed information 51022 is stored in the 1023ch-th output memory 31023. The determination unit 3 reads the 1022ch-th processed information 51022 from the 1023ch-th output memory 31023 and determines whether the value of the 1022ch-th processed information 51022 is a value within the predetermined range (0 to 16,383). In this case, since the value is outside the predetermined range, it is determined that the processing unit 1 has a failure. Moreover, the determination unit 3 outputs the 1022ch-th processed information 51022 as invalid information that is outside the range of values of information to be processed by the processing unit 1.

[Processing]

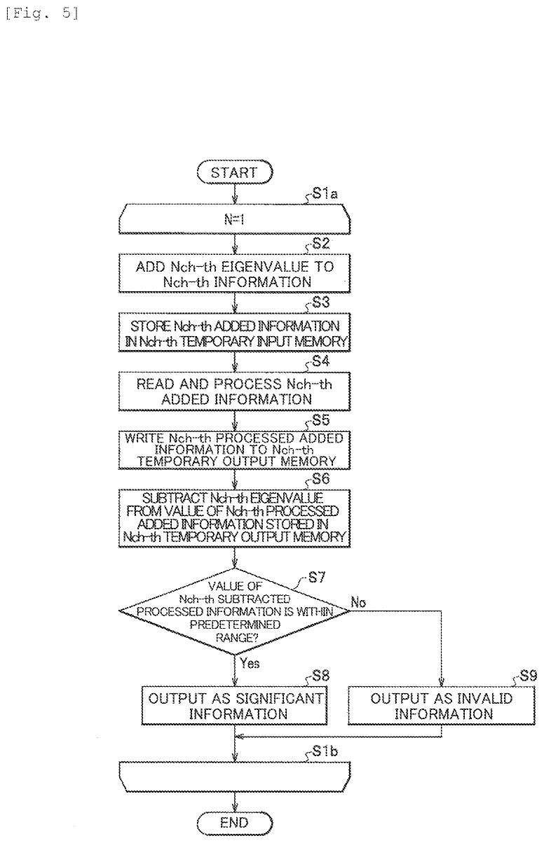

Next, the processing of the information processing device 100 will be described with reference to FIG. 5. This processing starts when 1024ch pieces of information is input to the information processing device 100,

First, the information processing device 100 performs loop processing for a variable N (N=0, 1, . . . , 1022, 1023) with respect to steps S1 (S1a, S1b ) to step S9. Subsequently, the information processing device 100 adds an Nch-th eigenvalue to Nch-th information with the aid of the addition unit 2A (step S2). Subsequently, the information processing device 100 stores the Nch-th added information in the Nch-th temporary input memory (step S3).

Subsequently, the information processing device 100 reads the Nch-th added information from the Nch-th temporary input memory and processes the same with the aid of the processing unit 1 (step S4). In this case, the processing unit 1 retains the Nch-th eigenvalue. Subsequently, the information processing device 100 writes the Nch-th processed added information to the Nch-th temporary output memory with the aid of the processing unit 1 (step S5).

Subsequently, the information processing device 100 subtracts the Nch-th eigenvalue from the value of the Nch-th processed added information stored in the Nch-th temporary output memory with the aid of the subtraction unit 2B (step S6). In this case, the subtraction unit 2B writes the Nch-th subtracted processed information to the Nch-th output memory. Subsequently, the information processing device 100 determines whether the value of the Nch-th subtracted processed information is within the predetermined range with the aid of the determination unit 3 (step S7).

When the value is within the predetermined range (step S7: Yes), the information processing device 100 determines that the processing unit 1 is normal and outputs the processed information stored in the Nch-th output memory as significant information with the aid of the determination unit 3 (step S8). After that, the information processing device 100 performs loop processing on the next information. On the other hand, when the value is outside the predetermined range (step S7: No), the information processing device 100 determines that the processing unit 1 has a failure and outputs the processed information stored in the Nch-th output memory as invalid information with the aid of the determination unit 3 (step S9). After that, the information processing device 100 performs loop processing on the next information.

When the loop processing has been executed for all N, the processing of information processing device 100 ends.

According to the present embodiment, even when the processing unit 1 that processes a plurality of pieces of information has a failure, only significant information can be output.

Therefore, even when the processing unit 1 that processes a plurality of pieces of information has a failure, it is possible to prevent significant information from being output erroneously.

Moreover, a simple means based on a channel number of an input memory can be provided as means for setting an eagenvalue.

(Others)

(a) In the present embodiment, processed information is output as significant information (step S8 in FIG. 5) if the value of the subtracted processed information is within the predetermined range, and the processed information is output as invalid information (step S8 in FIG. 5) if the value is outside the predetermined range. However, for example, if the value of the subtracted processed information is outside the predetermined range for one channel, all pieces of processed information may be output as invalid information.

(b) In the present embodiment, it has been described that the processing of FIG. 5 starts when 1024ch pieces of information is input to the information processing device 100. However, the processing of FIG. 5 may start when only 1023ch or smaller pieces of information is input. For example, there may be a case where 1024ch pieces of information are not available since there are a few customers making calls. In such a case, the information. processing device 100 can perform the processing of FIG. 5 on the input information.

(c) In the present embodiment, it has been described that the determination unit 3 determines whether the processing unit 1 is normal and outputs the processed information stored in the Nch-th output memory as significant information or invalid information (steps S7 to S9 in FIG. 5). However, in determination of the determination unit 3, the function of determining whether the processing unit 1 is normal may be omitted. When the processing unit 1 has a failure, even if the determination unit 3 does not determine that the processing unit 1 has a failure, the value of the subtracted processed information is outside the predetermined range (0 to 16,383). Even if the processed information is output to a receiver from the information processing device 100, such processed information is invalid information and is not recognized as significant information by the receiver.

A technique obtained by appropriately combining various techniques described in the present embodiment can be implemented.

### REFERENCE SIGNS LIST

100 Information processing device
1 Processing unit
2A Addition unit
2B Subtraction unit
3 Determination unit
20000 to 21023 Input memory
30000 to 31023 Output memory
40000 to 41023 (Non-processed) Information
50000 to 51023 (Processed) Information
60000 to 61023 (Non-processed) Added information
70000 to 71023 (Processed) Added information
80000 to 81023 Temporary input memory
90000 to 91023 Temporary output memory

1. An information processing device including a processing unit configured to process a plurality of pieces of information, comprising:
input memories configured to store respective pieces of the plurality of pieces of information;
an addition unit, including one or more processors, configured to add eigenvalues for respective input memories to values of the plurality of pieces of information and generate a plurality of pieces of added information so that there is no overlap of the values between the plurality of pieces of added information;
a subtraction unit, including one or more processors, configured to subtract the eigenvalues of the respective input memories from the respective pieces of the plurality of pieces of added information processed by the processing unit and generate a plurality of pieces of processed information;
output memories configured to store respective pieces of the plurality of pieces of processed information; and
a determination unit, including one or more processors, configured to determine whether a value of the processed information stored in each of the output memories is within a predetermined range and output the processed information as invalid information when the value is outside the predetermined range.

2. The information processing device according to claim 1, wherein the eigenvalues are set on a basis of a channel number of the input memories and a range of values that the plurality of pieces of information can take.

3. An information processing method in an information processing device including a processing unit configured to process a plurality of pieces of information, the information processing device executing:
storing respective pieces of the plurality of pieces of information in input memories;
adding eigenvalues for respective input memories to values of the plurality of pieces of information and generating a plurality of pieces of added information so that there is no overlap of the values between the plurality of pieces of added information;
subtracting the eigenvalues of the respective input memories from the respective pieces of the plurality of pieces of added information processed by the processing unit and generating a plurality of pieces of processed information;
storing respective pieces of the plurality of pieces of processed information in output memories; and
determining whether a value of the processed information stored in each of the output memories is within a predetermined range and outputting the processed information as invalid information when the value is outside the predetermined range.

4. The information processing method according to claim 3, wherein the eigenvalues are set on a basis of a channel number of the input memories and a range of values that the plurality of pieces of information can take.
